(19) United States
(12) Patent Application Publication
(10) Pub. No.: US 2018/0046361 A1
(43) Pub. Date: Feb. 15, 2018

(54) Fitting Content to a Resized Frame

(71) Applicant: Adobe Systems Incorporated, San Jose, CA (US)

(72) Inventors: Abhishek Shah, Delhi (IN); Sameer Bhatt, Noida (IN); Sagar Tandon, Ghaziabad (IN); Komal Kumar Desai, Noida (IN)

(73) Assignee: Adobe Systems Incorporated, San Jose, CA (US)

(21) Appl. No.: 15/232,065

(22) Filed: Aug. 9, 2016

(51) Int. Cl. G06F 3/0484

(52) U.S. Cl. CPC G06F 3/04845; G06F 3/04842

(57) ABSTRACT

Fitting content to a resized frame is described. In one or more embodiments, input is received to resize a frame that defines a boundary for a content item in a layout of content. For example, a user grabs a handle of the frame and drags the handle horizontally or vertically to resize the frame. In so doing, the aspect ratio of the frame is changed. A content fitting module fits the content item to the frame so that when the content item is displayed, the content item does not appear distorted and is contained within the frame. To do so, the content fitting module proportionally scales the content item based on an amount the frame is resized, repositions the content item to align a center of the content item with a center of the resized frame, and crops the scaled and repositioned content item according to the resized frame.

### BACKGROUND

Computing technologies allow users to interact with digital content, such as images, movies, and audio recordings in a variety of different ways. One way users can interact with digital content is to edit it. Content editing applications provide users with tools to modify digital content in a seemingly endless number of ways. Image editing applications, for instance, allow users to crop images, resize them, rotate them, blur them (or portions), apply filters so that the images (or portions) are adjusted depending on the filter, and so forth. Editing applications for other types of content also enable users to modify those other types of content in a wide variety of different manners.

Content editing applications also allow users to combine multiple content items into a single presentation. For example, some content editing applications allow users to arrange multiple digital images to form a collage, e.g., a single image formed from an arrangement of multiple different images. Content editing applications can also be used to arrange one or more images with one or more videos, text with images and videos, videos with other videos, and so on. In other words, content editing applications can be used to arrange different types of content together into a single presentation, such as image collages, multi-track video collages, picture-in-picture (“PIP”) presentations, and so forth. One operation commonly performed by users when arranging content in a multi-item layout is to resize one or more of the content items. A user may, for instance, wish to make one piece of content placed in the layout larger or smaller in one of a vertical direction or horizontal direction. Conventional techniques for resizing content items in multi-item layouts may not allow the user to easily resize individual items of the content in a manner the user desires. Instead, the user may have to perform several manual operations in order to resize a content item in the desired manner. However, doing so may be tedious and time-consuming consequently, users may simply decide not to resize content in some ways.

### SUMMARY

Fitting content to a resized frame is described. In one or more embodiments, input is received to resize a frame that defines a boundary for a content item in a layout of content. For example, a user grabs a handle of the frame and drags the handle horizontally or vertically to resize the frame. In so doing, the aspect ratio of the frame is changed. A content fitting module fits the content item to the frame so that when the content item is displayed, the content item does not appear distorted and is contained within the frame. To do so, the content fitting module proportionally scales the content item based on an amount the frame is resized, repositions the content item to align a center of the content item with a center of the resized frame, and crops the scaled and repositioned content item according to the resized frame.

When the content item corresponds to a video, the content fitting module first fits a reference frame of the video to the resized frame, e.g., by proportionally scaling, repositioning, and cropping the reference frame. As part of fitting the reference frame to the resized frame, the content fitting module determines scaling parameters, repositioning parameters, and cropping parameters indicative of the scaling, repositioning, and cropping, respectively, of the reference frame. These parameters are saved and then used to fit the other frames of the video to the resized frame. The content item as fit to the resized frame is then displayed in the layout. In one or more embodiments, the content item is included in a content layout configured as at least one of an image collage, a multi-track video collage, or a picture-in-picture presentation.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example embodiment that is operable to employ techniques described herein.

FIG. 2 is an example depicting an initial multi-item layout of content and a resizing of a content item in a manner that simply maintains an aspect ratio of the content.

FIG. 3 is an example depicting a resizing of the content item in a manner that distorts the content item and another resizing of the content item to fit the content item to the resized frame in accordance with one or more embodiments.

FIG. 4 is a flow diagram depicting an example procedure in accordance with one or more embodiments.

FIG. 5 is a flow diagram depicting another example procedure in accordance with one or more embodiments.

FIG. 6 illustrates an example system including various components of an example device that can be employed for one or more embodiments of the fitting content to a resized frame described herein.

### DETAILED DESCRIPTION

Overview

Fitting content to a resized frame is described. An input is initially received to resize the frame that corresponds to the content. Based on this, the content is fit to the resized frame by scaling, repositioning, and cropping the content. In particular, the scaling, repositioning, and cropping fits the content to the frame so that the content does not appear distorted in the resized frame.

To do so, the content is scaled proportionally in accordance with the resizing input. The scaled content is also repositioned relative to the resized frame and cropped to fit the frame. Repositioning the content involves moving the content so that a center point of the content is positioned at a center of the resized frame. Cropping the content involves cropping the scaled and repositioned content according to the shape of the frame. In this way, the content is contained within the boundaries of the frame. It is to be appreciated that computations for the scaling, repositioning, and cropping may be performed, and then a result (e.g., the content fit to the frame) displayed. Accordingly, a user does not see the content being proportionally scaled based on the resizing of the frame, repositioned relative to the frame, or cropped to fit within the frame.

Consider an example in which a user wishes to resize a rectangular content item, such as an image. In this example assume that the input to resize the image corresponds to grabbing a right side of the image (e.g., using a handle along the right edge) and dragging the grabbed right side to the right by some distance. In accordance with the techniques described herein, a height of the frame (the area in which the image is contained) is the same before and after the grabbing and dragging input. However, the frame is wider by the distance the user dragged the right side of the frame.

The example image is then scaled, repositioned, and cropped to fit the resized frame in accordance with the described techniques. By fitting the image in this way, the image does not appear distorted in the resized frame. Given this example in which the frame of the image is horizontally increased, fitting the image involves scaling it proportionally according to the horizontal increase. Assume for example, that before being increased the image and its frame have dimensions of 16 units horizontally by 9 units vertically. Assume also that the frame is increased horizontally by 4 units, e.g., a user input is received to drag a side edge of the frame so that it is 4 units wider. Based on this input, the frame is resized to be 20 units wide by 9 units tall. The image, however, is not merely stretched 4 units wider. Instead, the image is scaled so that it is 20 units wide and 11.25 units tall. The scaled image is also repositioned relative to the resized frame and cropped to fit the frame. The image is repositioned to position a center of the image at a center of the resized frame. In accordance with the described techniques, the scaled and repositioned image is also cropped according to the 20-unit by 9-unit frame to contain the image within the frame boundaries.

Fitting content to a frame in this way allows users to easily resize an item of content in a single direction without distorting the content. It also allows users to manipulate content so that the content stays within a desired frame size, rather than expand both height and width to maintain an aspect ratio of the content. Another advantage of the described techniques is that they fit content to a resized frame without further user input to reposition and crop the content. These techniques can thus save time for users and encourage users to resize content in manners they may have previously avoided.

### Term Descriptions

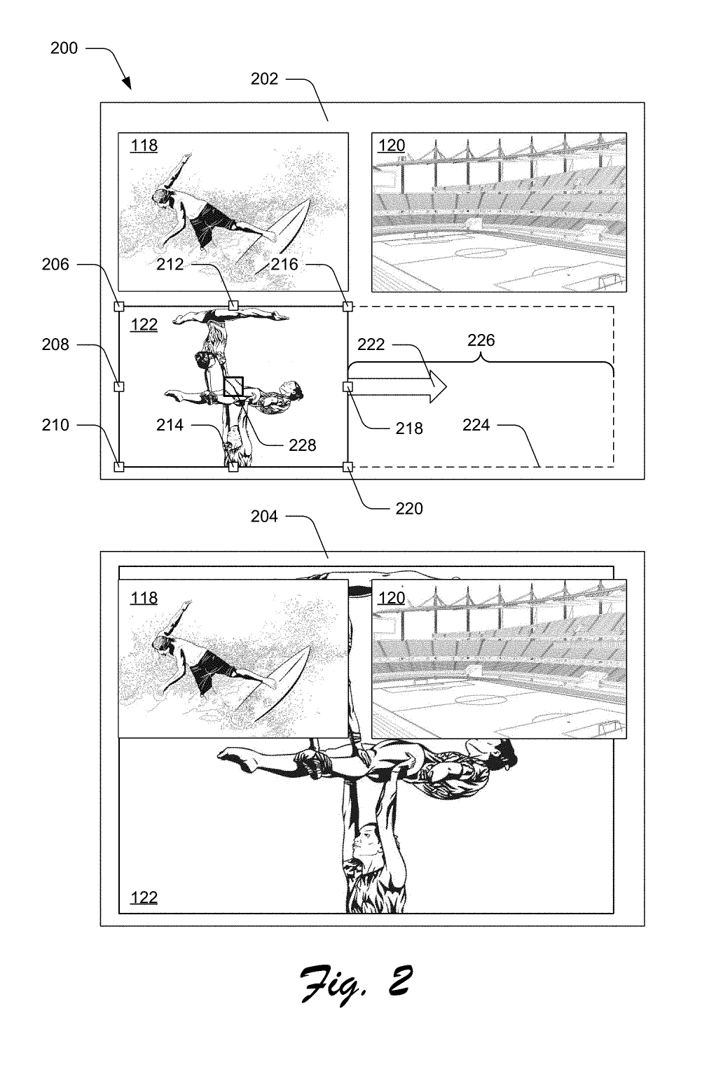

As used herein, the term “frame” may refer to an area of a layout to which a content item is restricted. The frame may also include controls that are selectable to resize the content, such as handles at the corners and the sides of the frame as shown in FIG. 2. A frame of content may have a boundary, and be filled with a respective content item. By way of example, a frame containing an image may be rectangular, have a height of x pixels, and a width of y pixels. Additionally, this frame may be filled by the respective image, or portions of the image.

With regard to video, a “frame” may not only refer to the area of a layout to which a video is restricted, as described just above, but a “frame” may also refer to an electronically coded still image of the video, which when viewed together with other frames in a sequence results in playback of the video. This second definition of frame is used herein when discussing how videos are resized to fit the first defined type of frame. However, when used in the context of the second definition (e.g., the single coded still image), the term “frame”, is used along with the term “reference” or “other” to form the term a reference frame of video and the term other frames of video. A “reference frame” refers to a single still image of video on which operations of the techniques described herein are initially carried out. The term “other frames” refers to other images of the sequence of images that form the video to which the operations performed on the reference frame are carried over. For instance, to fit a video to a frame (e.g., the area of the layout specified for containing the video) a reference frame of the video may be cropped. Based on this cropping, the other frames of the video may be cropped in a similar manner.

Further, the term “layout” refers to an arrangement of content in which one or more items of the content are organized for presentation to a user, such as for display to the user. A content “item” refers to an image, video, text box, vector graphic, and so forth. A “multi-item layout” refers to a layout that includes multiple items of content. A multi-item layout can include a single type of content item (e.g., multiple images) or multiple different types of content items (e.g., one or more images and one or more videos). One familiar type of multi-item layout is a “collage,” which can include multiple images arranged according to a predefined template or to some user-specified arrangement. Content may be fit to a resized frame in a variety of different multi-item layouts without departing from the spirit or scope of the techniques described herein, such as collages, PIP presentations, electronic picture frames, electronic cards (“e-cards”), electronic billboards, web pages, and other combinations of content items.

In the following discussion, an example environment is first described to employ the techniques described herein. Example implementation details and procedures are then described which are performable in the example environment as well as other environments. Consequently, performance of the example procedures is not limited to the example environment and the example environment is not limited to performance of the example procedures.

### Example Environment

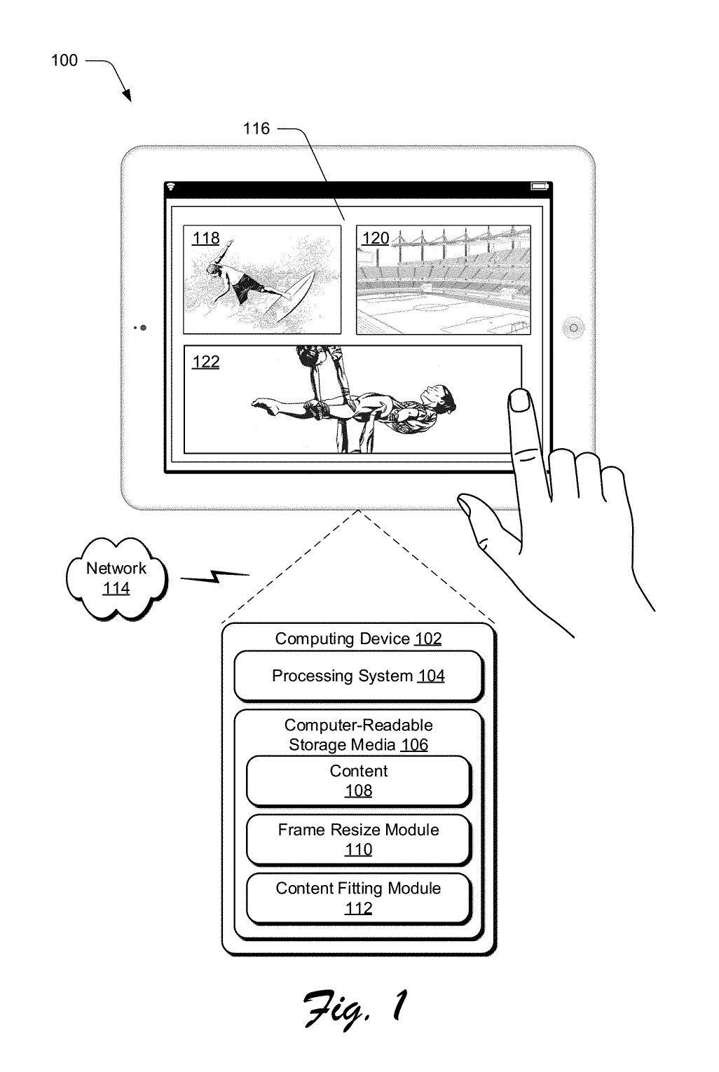

FIG. 1 is an illustration of an environment 100 in an example embodiment that is operable to employ techniques described herein. The illustrated environment 100 includes a computing device having a processing system 104 that includes one or more processing devices (e.g., processors) and one or more computer-readable storage media 106. The illustrated environment 100 also includes applications, and content 108, as well as a frame resize module 110 and a content fitting module 112 embodied on the computer-readable storage media 106 and operable via the processing system 104 to implement corresponding functionality described herein. In at least some embodiments, the computing device 102 includes functionality to access various kinds of web-based resources (content and services), interact with online providers, and so forth as described in further detail below.

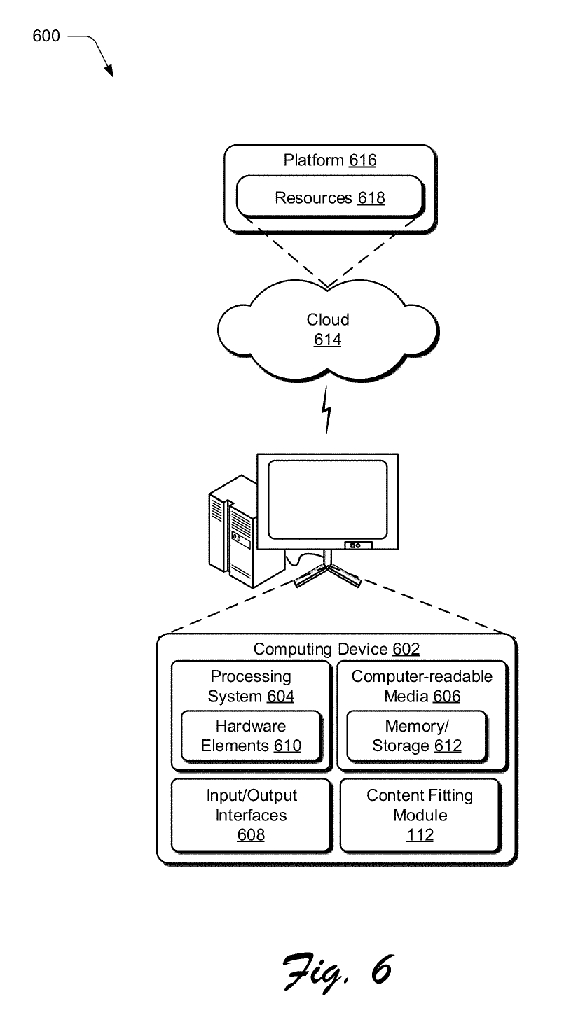

The computing device 102 is configurable as any suitable type of computing device. For example, the computing device 102 may be configured as a server, a desktop computer, a laptop computer, a mobile device (e.g., assuming a handheld configuration such as a tablet or mobile phone), a tablet, a device configured to receive gesture input, a device configured to receive three-dimensional (3D) gestures as input, a device configured to receive speech input, a device configured to receive stylus-based input, a device configured to receive a combination of those inputs, and so forth. Thus, the computing device 102 may range from full resource devices with substantial memory and processor resources (e.g., servers, personal computers, game consoles) to a low-resource device with limited memory and/or processing resources (e.g., mobile devices). Additionally, although a single computing device 102 is shown, the computing device 102 may be representative of a plurality of different devices to perform operations “over the cloud” as further described in relation to FIG. 6.

The computing device 102 is further operable to communicate over a network 114, such as the Internet, to provide a “cloud-based” computing environment. Generally speaking, service providers are configured to make various resources available over the network 114 to clients. In some scenarios, users sign up for accounts that are employed to access corresponding resources from a provider. The provider authenticates credentials of a user (e.g., username and password) before granting access to an account and corresponding resources. Other resources are made freely available, (e.g., without authentication or account-based access). The resources can include any suitable combination of services and/or content typically made available over a network by one or more providers. Some examples of services include, but are not limited to, content creation services that offer content editing and arranging applications (e.g., Creative Cloud® and the like), content storage and/or sharing services, social network services (e.g., Facebook®, Twitter®, Instagram®, Hyperlapse®, and the like), and so forth.

Service providers may serve as sources of significant amounts of content. Content 108 represents content items that are accessible to a user of the computing device 102. The content 108 represents a variety of different content that may be stored at the computing device 102 or accessible at least temporarily to a user. By way of example, and not limitation, the content 108 can include, images, videos, text, vector graphics, audio clips, and so on. Regardless of the content 108 maintained by or accessible via the computing device 102, it can be formatted in any of a variety of different digital formats. When the content 108 corresponds to an image or includes an image, for instance, the image can be formatted in formats including but not limited to JPEG, TIFF, RAW, GIF, BMP, PNG, and so on. Since the content 108 may correspond to a variety of different types of content, the content 108 can include a variety of differently formatted files. In any case, the content 108 may represent a variety of types of content without departing from the spirit or scope of the techniques described herein.

The frame resize module 110 and the content fitting module 112 represent functionality to implement aspects of techniques for fitting content to a resized frame. Consider an example in which a user of the computing device 102 forms a layout 116 having multiple content items 118, 120, 122, as depicted in FIG. 1. These content items 118, 120, 122 are examples of the content 108. Specifically, the illustrated example 100 represents a scenario in which the content item 122 has been fit to a corresponding frame, which has been resized based on a touch input from a user of the computing device 102. The frame and the content item 122 may have been widened from an initial size of the content item 122, such as from the example arrangement in FIG. 2 that depicts the content item 122 before being resized.

The frame resize module 110 represents functionality to resize a frame of the content item 122. As mentioned above, a frame is an area of the layout 116 within which the content item 122 is contained, and includes controls that are selectable to resize the frame. The controls may be configured as handles that can be selected and dragged to enable the resizing. For instance, a handle on a left or right side of a rectangular frame may allow a user to widen the content by dragging one of those handles outward from an initial position. In a similar manner, a handle of a top or bottom side of the rectangular frame may allow a user to increase a height of the content by dragging a top handle upward or a bottom handle downward. These handles can also allow a user to decrease the size of the frame by dragging side handles inward, top handles downward, and bottom handles upward. In any case, the content fitting module 112 receives an input to resize a frame of the content item 122. The input may be touched based, from a stylus or a mouse, based on a voice command, based on keystrokes from a keyboard, and so on.

Based on this input, the frame resize module 110 defines a resized area of the layout 116 within which the content item 122 is to be contained. For example, if the user input to resize the content item 122 drags a right-side handle 4 units to the right, then the frame resize module 110 increases a width of the content item 122's frame by 4 units. Assume, for instance, that an initial size of the content item 122 is 16 units wide by 9 units tall and that user input is received to increase a width of the content item 122 by 4 units. The frame resize module 110 is configured to define the resized frame for the content as 20 units wide and 9 units tall. In accordance with one or more embodiments, the frame resize module 110 also represents functionality to anchor the content item 122 based on its position in the layout 116 before a resizing input is received. By “anchored” it is meant that a side of the content item 122 opposite the side the resizing input is received for remains in a same position of the layout 116. For instance, if the content item 122's frame is widened based on input dragging a right-side handle further to the right, a left side of the frame is in a same position both before and after the resizing.

Regardless of the resizing (e.g., increasing width or height of the frame or decreasing width or height of the frame) the content fitting module 112 represents functionality to fit the content to the resized frame. Continuing with the example above in which input is received to resize the content item 122's frame, the content fitting module 112 represents functionality to fit the content item 122 to the resized frame. To do so, the content fitting module 112 scales, repositions, and crops the content item 122 to fit the resized frame. With regard to scaling the content item 122, the content fitting module 112 scales the content item 122 proportionally according to the resized frame. The content item 122 is scaled to fill the frame across a span corresponding to the resizing input. As a result of the scaling and before being repositioned and cropped, the content may extend beyond the frame in at least one other direction. By scaling the content item 122 proportionally, the content item 122 will not appear distorted, e.g., stretched or compressed, when eventually displayed.

The content fitting module 112 also repositions the content item 122 relative to the frame. To do so, the content fitting module 112 determines a center of the content item 122, e.g., a center point of the content before input is received to resize the content. The content fitting module 112 also determines a center of the resized frame. The content fitting module 112 repositions the content item 122 so that the determined center point of the content is located at the determined center of the resized frame. The content fitting module 112 also represents functionality to crop the content item 122. For instance, once the content item 122 is scaled and repositioned in the manner discussed above, the content fitting module 112 crops the scaled and repositioned content according to the resized frame. In other words, the content fitting module 112 crops the scaled and repositioned content along the boundaries of the resized frame. To this extent, the scaled and repositioned content fills the resized frame. The repositioning also keeps a focus of the content item 122 at the center. After being scaled, repositioned, and cropped, the content item 122 may be displayed as part of the layout 116. When displayed, the content item 122 fits within the resized frame.

In one or more embodiments, the frame resize module 110 and the content fitting module 112 are implementable as software modules, hardware devices, or using a combination of software, hardware, firmware, fixed logic circuitry, etc. Further, the frame resize module 110 and the content fitting module 112 can be implementable as standalone components of the computing device 102 as illustrated. In addition or alternatively, the frame resize module 110 and the content fitting module 112 can be configured as components of a web service, an application, an operating system of the computing device 102, a plug-in module, or other device application as further described in relation to FIG. 6.

Having considered an example environment, consider now a discussion of some example details of the techniques for fitting content to a resized frame in accordance with one or more embodiments.

Fitting Content to a Resized Frame

This section describes some example details of techniques for fitting content to a resized frame in accordance with one or more embodiments. FIG. 2 depicts examples, generally at 200, of multi-item layouts of content. In particular, FIG. 2 includes layouts 202, 204. The layouts 202, 204 both include the multiple items of content 118, 120, 122 depicted in FIG. 1.

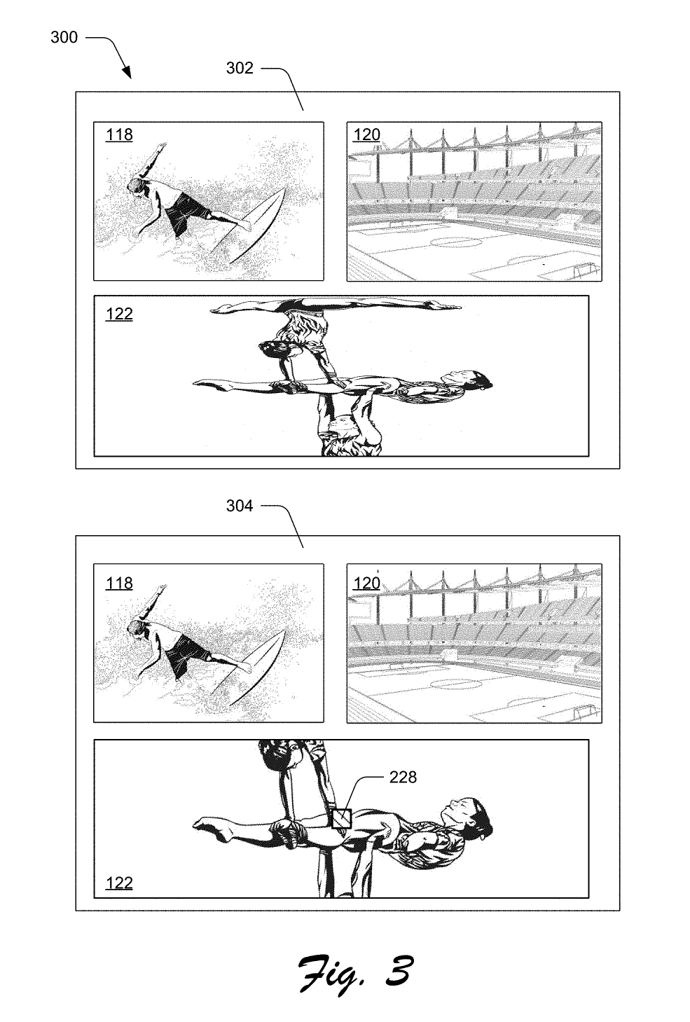

In the illustrated example 200, the layout 202 includes resizing handles 206, 208, 210, 212, 214, 216, 218, 220. The resizing handles 206, 208, 210, 212, 214, 216, 218, 220 represent functionality to resize a frame of the content item 122. The illustrated example 200 also includes arrow 222 and frame indication 224. The arrow 222 represents an input to select the resizing handle 218, and drag the resizing handle 218 to resize the content item 122's frame. In particular, the arrow 222 represents an input to drag the resizing handle 218 distance 226 so that the frame of the content item 122 has a size indicated by the frame indication 224. Further, the content item 122 is illustrated with content center 228, which represents a center point that is determined for the content item 122. The content center 228 is referred to below in the discussion of FIG. 3.

Continuing with the discussion of the layout 202, it may represent an initial arrangement of the multiple content items 118, 120, 122. For instance, the layout 202 may represent an arrangement of the content items 118, 120, 122 before the content item 122 is resized, e.g., according to the input represented by the arrow 222. Thus, the frame indication 224 represents a desired increase in size of the content item 122. The frame indication 224 also indicates that a desired height of the content item 122 is not to change. In other words, the height of the content item 122, after being fit to the resized frame, is to be the same as the height of the content item 122 before the resizing input. The resizing handle 218, for instance, may be movable to resize the frame of the content item 122 in just two directions—to the right to expand the width of the content item 122 or to the left to decrease the width of the content item 122. By resizing the content item 122 with one of the resizing handles 208, 212, 214, 218, a user may indicate a desire to resize the content in just a single direction while maintaining dimensions of the content item 122 in other directions.

In contrast, the layout 204 represents a scenario in which the content item 122 is scaled, but not further fit to a frame. When a user selects the resizing handle 218 and drags it the distance 226, many conventional techniques may merely scale the content item 122 as illustrated in the layout 204, e.g., without further fitting the content item 122 to the frame. In the layout 204, the scaled content item 122 has a same aspect ratio as in the initial arrangement. Although the content item 122 remains proportional and does not appear distorted in the layout 204, a user may not want the content item 122 to have the increased height. With the increased height, the content item 122, extends beyond the frame indication 224 and up into areas where the content items 118, 120 are positioned. In the illustrated example 200, portions of the content item 122 are covered by the content items 118, 120, which may be undesirable. The layout 204 does not keep the content item 122 contained within a frame indicated by the frame indication 224. The content item 122 is not “fit” to the resized frame in the layout 204.

FIG. 3 also depicts examples, generally at 300, of multi-item layouts of content. In particular, FIG. 3 includes layouts 302, 304, both of which include the content items 118, 120, 122.

The layout 302 represents a scenario in which the content item 122 is stretched to be contained within a resized frame. The layout 302 represents another manner in which conventional techniques adjust content based on a resizing input in one direction. When a user selects the resizing handle 218 and drags it the distance 226, for instance, some conventional techniques stretch the content item 122 as illustrated in the layout 302, e.g., without maintaining a proportionality of the content item 122. When such conventional techniques are used, the content item 122 can appear distorted, which may be undesirable. In the layout 302, the content item 122 is adjusted to fill the frame indication 224, but appears stretched horizontally and compressed vertically. In other words, in the layout 302 the content item 122 may fill the frame but appears distorted. In contrast to conventional resizing techniques, the techniques described herein adjust the content item 122 to fit within a frame without distorting the content item 122.

The layout 304 represents an example of fitting content to a resized frame in accordance with the techniques herein. Unlike the layout 204, the content item 122 in the layout 304 is contained within the resized frame. Further and unlike the layout 302, the content item 122 in the layout 304 is not simply stretched to fit the frame. Rather, the content item 122 is fit to the resized frame in a manner that maintains the proportionality of the content in the layout 304.

To do so, the content item 122 is scaled, repositioned, and cropped as discussed above. First, an input to resize a frame of the content item 122 is received, e.g., the input that corresponds to the arrow 222 to resize the content item 122 so that it has a size represented by the frame indication 224. Based on this input, the frame resize module 110 adjusts values that define the frame of the content item 12 to reflect a new size of the frame.

The content fitting module 112 scales the content item 122 according to the new size of the frame. For instance, the content fitting module 112 scales the content item 122 to cover a span that corresponds to the resizing input. Given an input that corresponds to the arrow 222, for instance, the content fitting module 112 may scale the content item 122 so that it has a same size as in the layout 204.

Unlike conventional techniques, the techniques described herein continue beyond simply scaling the content item 122. Indeed, the techniques described herein also reposition and crop the content item 122. With reference back to the content center 228, the content fitting module 112 repositions the content item 122 so that the content center 228 is located at a center of the resized frame. The difference in position of the content center 228 between the layout 202 and the layout 304 demonstrates this repositioning. Additionally, the content fitting module 112 crops the scaled and repositioned content to fit the resized frame. Note that in the layout 304, the content item 122 does not include some of the portions that are included in the layout 202. In particular, a top portion and a bottom portion of the content item 122 have been cropped. Once the content item 122 is scaled and repositioned, the content fitting module 112 crops the content item 122 according to the resized frame. The resized frame thus defines the boundaries of the scaled and repositioned content. In so doing, the content fitting module 112 fits the content item 122 to the resized frame, e.g., so that the content fills the frame 122 and does not appear distorted.

With regard to fitting video to a resized frame, the content fitting module 112 may perform the scaling, repositioning, and cropping for a single frame of the video content, e.g., a reference frame. The content fitting module 112 may then propagate the scaling, repositioning, and cropping changes to the other frames of the video content so that each frame of the video content “fits” in the resized content frame in the manner described. Other content such as text boxes, vector graphics, and so forth may be fit into a resized frame in a similar manner without departing from the spirit or scope of the techniques described herein.

By fitting content to a resized frame in the manner described, the process of editing content in a layout to fit a resized frame is simplified. In particular, the techniques described herein fit content to a frame resized in a single direction without further user interaction. Thus, the described techniques reduce user interaction by eliminating the user-driven repositioning and cropping that some conventional techniques involve in order to achieve some resizings of the content.

Having discussed example details of the techniques for fitting content to a resized frame, consider now some example procedures to illustrate additional aspects of the techniques.

### Example Procedures

This section describes example procedures for techniques of fitting content to a resized frame in one or more embodiments. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In at least some embodiments the procedures may be performed by a suitably configured device, such as example computing device 102 of FIG. 1 that makes use of a frame resize module 110 and content fitting module 112.

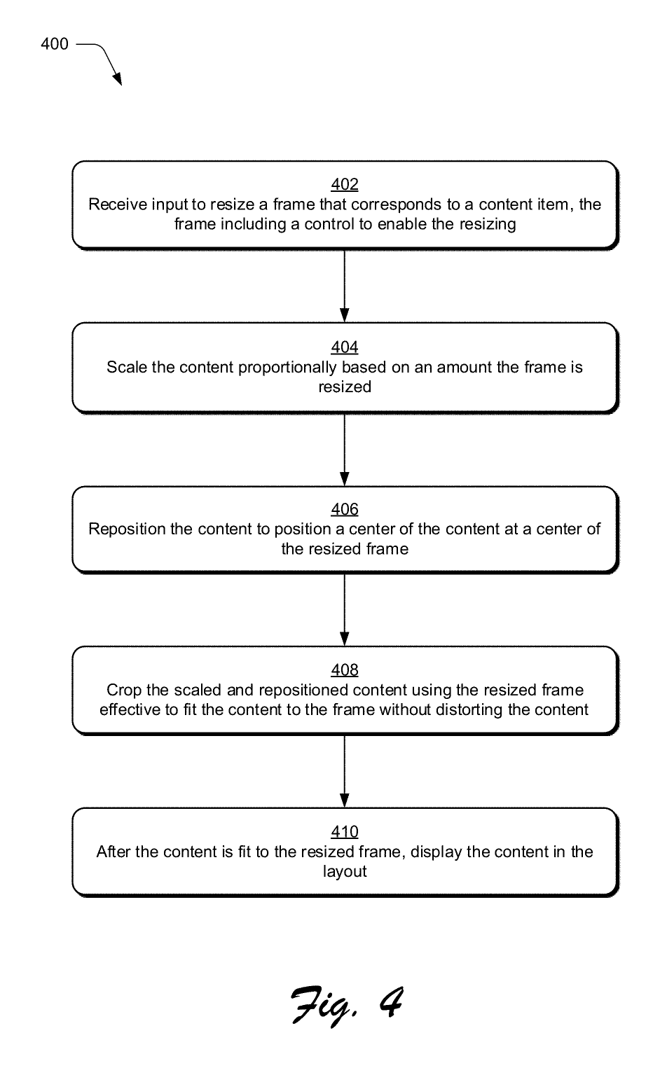

FIG. 4 depicts an example procedure 400 in which content in a layout is fit to a resized frame by scaling, repositioning, and cropping the content based on the resized frame. An input to resize a frame corresponding to a content item in a layout of content items is received (block 402). In accordance with the principles discussed herein, the frame includes at least one control to enable the resizing. For example, the frame resize module 110 receives a user input that corresponds to the arrow 222 to drag the resizing handle 218 the distance 226. The frame indication 224 indicates a boundary of the resized frame that results from such input. In one or more embodiments, the frame is displayed as a box surrounding the content item 122 (both before and after the resizing). The frame includes controls, such as the resizing handles 206, 208, 210, 212, 214, 216, 218, 220, that enable the content item 122 to be resized.

The content item is fit to the resized frame without distorting the content item. In accordance with the principles discussed herein, the content “fits” the resized frame if it is contained within the boundaries of the resized frame and does not extend beyond them in any direction. Additionally, the content is not distorted insofar as it does not appear stretched or compressed. As part of fitting the content item to the resized frame, the content item is scaled proportionally based on an amount the frame is resized (block 404). For example, the content fitting module 112 scales the content item 122 based on the distance 226. To do so, the content fitting module 112 determines one or more scaling parameters that can be used to scale the content item 122 according to an amount the frame is resized. Although the scaled content item 122 is not displayed to the user, it is proportionally scaled based on the distance 226. As a result, the content item 122 as scaled may have a same size as in the layout 204.

The content is repositioned to position a center of the content at a center of the resized frame (block 406). For example, the content fitting module 112 determines a center point of the content item 122, e.g., content center 228. The content fitting module 112 also determines a center point of the resized frame, e.g., the frame indicated by the frame indication 224. In conjunction with these determinations, the content fitting module 112 determines one or more repositioning parameters that can be used to reposition the content item 122. The content fitting module 112 then repositions the content item 122 so that the content center 228 of the content item 122 aligns with the determined center of the resized frame.

Further, the scaled and repositioned content is cropped using the resized frame (block 408). For example, the content fitting module 112 crops the content item 122 as scaled and repositioned according to blocks 404, 406, respectively, using the resized frame. In particular, the content fitting module 112 crops the content item 122 along the boundary of the resized frame. To do so, the content fitting module 112 determines one or more cropping parameters indicative of the boundary defined by the resized frame and that are useable to crop the scaled and repositioned content item. The portions of the content item 122 outside the resized frame can be discarded or otherwise removed.

After the content is fit to the resized frame, the content is displayed as part of the layout (block 410). For example, the computing device 102 displays the layout 304, which includes the content item 122 fit to the resized frame. In particular, the content item 122 in the layout 304 is proportionally scaled so that it does not appear stretched as in the layout 302. In the layout 304, the content item 122 is also contained within the resized frame—the content item 122 is not merely scaled as in the layout 204.

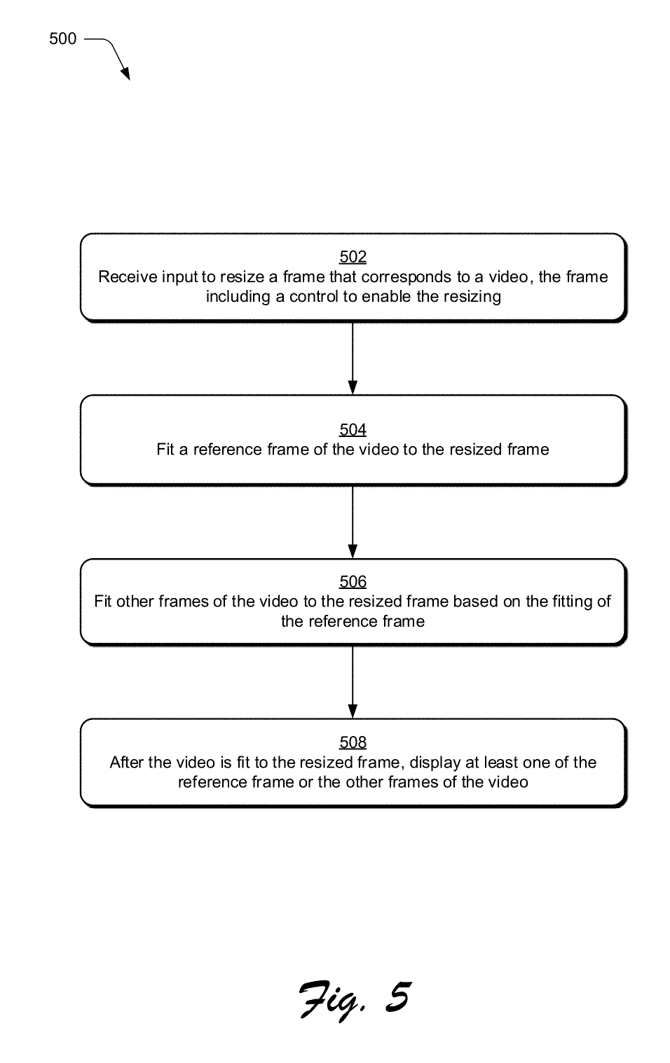

The techniques described in FIGS. 4-5 may be performed when an input is received to resize the content in a manner that will change its aspect ratio. In accordance with the techniques described herein, consider an input for resizing content in a single direction, e.g., vertically or horizontally. One example of such an input is to grab a handle along a side of the content to increase or decrease a size of the content in the horizontal direction alone. The layouts 202, 304 illustrate an example in which an input is received to expand a content item horizontally, though the techniques are also applicable with inputs to decrease a size of content horizontally, and inputs to increase or decrease the size of the content vertically. The described techniques may be used to fit content to frames resized in a variety of different ways without departing from the spirit or scope of those techniques.

FIG. 5 depicts an example procedure 500 in which a video is fit to a resized frame. An input to resize a frame that corresponds to the video is received (block 502). In accordance with the principles discussed herein, the frame includes at least one control to enable the resizing. Consider an example in which the content item 122 represents a video. In this example, the frame resize module 110 receives a user input that corresponds to the arrow 222 to drag the resizing handle 218 the distance 226. The frame indication 224 indicates a boundary of the resized frame that results from such input. Further, the frame includes controls, such as the resizing handles 206, 208, 210, 212, 214, 216, 218, 220, which enable the content item 122 to be resized.

A reference frame of the video is fit to the resized frame (block 504). For example, the content item 122 corresponds to a reference frame of video content. The content fitting module 112 fits the content item 122 to the frame indicated by the frame indication 224. The content fitting module 112 does so in the manner discussed in conjunction with FIG. 4, e.g., by scaling, repositioning, and cropping the content item 122. This results in the content item 122 being fit to the resized frame as in the layout 304. Based on fitting the reference frame of the video to the resized frame, other frames of the video are fit to the resized frame (block 506). Continuing with the example in which the content item 122 corresponds to the reference frame fit to the resized frame, for instance, the content fitting module 112 fits other frames of the respective video to the resized frame. Furthermore, the content fitting module 112 does so based on fitting the content item 122 to the resized frame at block 504. In particular, the content fitting module 112 saves parameters indicative of the scaling, repositioning, and cropping performed on the reference frame at block 504, e.g., one or more scaling parameters, one or more repositioning parameters, and one or more cropping parameters. The content fitting module 112 uses those parameters to fit the other frames of the video to the resized frame.

After the video is fit to the resized frame, at least one of the reference frame or the other frames of the video is displayed (block 508). For example, the computing device 102 displays the layout 304, which in the continuing example includes the content item 122 configured as a video. In any case, each frame of the video (both the reference and other frames) is fit to the resized frame. In particular, the video frames in the layout 304 are proportionally scaled so that the video frames do not appear stretched or compressed. Additionally, each frame of the video is contained within the resized frame—the video frames are not merely scaled like the content item 122 is in the layout 204.

Having described example procedures in accordance with one or more embodiments, consider now an example system and device that can be utilized to implement the various techniques described herein.

### Example System and Device

FIG. 6 illustrates an example system generally at 600 that includes an example computing device 602 that is representative of one or more computing systems and/or devices that may implement the various techniques described herein. This is illustrated through inclusion of the content fitting module 112, which operates as described above. The computing device 602 may be, for example, a server of a service provider, a device associated with a client (e.g., a client device), an on-chip system, and/or any other suitable computing device or computing system.

The example computing device 602 includes a processing system 604, one or more computer-readable media 606, and one or more I/O interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An embodiment of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

The techniques described herein may be supported by various configurations of the computing device 602 and are not limited to the specific examples of the techniques described herein. This functionality may also be implemented all or in part through use of a distributed system, such as over a “cloud” 614 via a platform 616 as described below.

The cloud 614 includes and/or is representative of a platform 616 for resources 618. The platform 616 abstracts underlying functionality of hardware (e.g., servers) and software resources of the cloud 614. The resources 618 may include applications and/or data that can be utilized while computer processing is executed on servers that are remote from the computing device 602. Resources 618 can also include services provided over the Internet and/or through a subscriber network, such as a cellular or Wi-Fi network.

The platform 616 may abstract resources and functions to connect the computing device 602 with other computing devices. The platform 616 may also serve to abstract scaling of resources to provide a corresponding level of scale to encountered demand for the resources 618 that are implemented via the platform 616. Accordingly, in an interconnected device embodiment, implementation of functionality described herein may be distributed throughout the system 600. For example, the functionality may be implemented in part on the computing device 602 as well as via the platform 616 that abstracts the functionality of the cloud 614.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device for reducing user interaction involved with resizing content items, the method comprising:
receiving a resizing input that resizes a frame corresponding to a content item, the frame defining a boundary of the content item in a layout of content;
fitting the content item to the resized frame by:
proportionally scaling the content item based on an amount the frame is resized,
repositioning the content item to align a center of the content item with a center of the resized frame, and
cropping the scaled and repositioned content item according to the resized frame; and
displaying the layout of content with the fit content item.

2. A method as described in claim 1, further comprising determining the center of the content item.

3. A method as described in claim 1, further comprising determining the center of the resized frame.

4. A method as described in claim 1, wherein the fit content item does not appear distorted.

5. A method as described in claim 4, wherein appearing distorted comprises at least one of appearing stretched in a direction or appearing compressed in a direction.

6. A method as described in claim 1, wherein the resizing input resizes the frame in one direction.

7. A method as described in claim 6, wherein the one direction is horizontally or vertically.

8. A method as described in claim 1, wherein the resizing input is received via a control of the frame that enables the frame to be resized one of vertically or horizontally.

9. A method as described in claim 1, wherein the content item comprises a reference frame of a video that includes other frames.

10. A method as described in claim 9, further comprising fitting the other frames of the video to the resized frame based on fitting the reference frame of the video to the resized frame.

11. A method as described in claim 10, further comprising:
determining one or more scaling parameters indicative of proportionally scaling the reference frame;
determining one or more repositioning parameters indicative of repositioning the reference frame;
determining one or more cropping parameters indicative of cropping the scaled and repositioned reference frame; and
wherein the other frames of the video are fit to the resized frame according to the one or more scaling parameters, the one or more repositioning parameters, and the one or more cropping parameters.

12. A method as described in claim 1, wherein the layout comprises at least one of a picture collage, a multi-track collage that includes multiple videos arranged in the layout, or a picture-in-picture presentation.

13. A method as described in claim 1, wherein the layout includes multiple different types of content.

14. A system for reducing user interaction involved with resizing content items, the system comprising:
one or more processors; and
computer-readable storage media having stored thereon instructions that are executable by the one or more processors to perform operations comprising:
defining a boundary of a content item in a layout of content using a frame configured to contain the content item and that includes controls which enable the frame to be resized;
responsive to receiving a resizing input via one of the controls to resize the frame, determining:
scaling parameters for proportionally scaling the content item according to an amount the frame is resized;
repositioning parameters for repositioning the content item to align a center of the content item with a center of the resized frame; and
cropping parameters for cropping the scaled and repositioned content item to the resized frame; and
fitting the content item within the resized frame so that the content item does not appear distorted when displayed based on the scaling parameters, the repositioning parameters, and the cropping parameters.

15. A system as described in claim 14, wherein the operations further comprise:
saving the scaling parameters, the repositioning parameters, and the cropping parameters when the content item corresponds to a reference frame of a video; and
fitting other frames of the video to the resized frame using the saved parameters.

16. A system as described in claim 14, wherein the operations further comprise displaying the layout, including the content item as fit to the resized frame.

17. A system as described in claim 14, wherein the resizing input changes an aspect ratio of the frame.

18. A method implemented by a computing device for reducing user interaction involved with resizing videos in layouts of content, the method comprising:
receiving a resizing input that resizes a frame corresponding to a video, the frame defining a boundary of the video in a content layout that includes the video;
fitting a reference frame of the video to the resized frame by scaling, repositioning, and cropping the reference frame;
fitting other frames of the video to the resized frame using parameters determined based on fitting the reference frame to the resized frame; and
displaying the content layout with at least one of the fit reference frame or the fit other frames of the video.

19. A method as described in claim 18, wherein the content layout is a picture-in-picture (PIP) arrangement of content that includes the video.

20. A method as described in claim 18, wherein the content layout includes the video and at least one other type of content.
